(19) United States
(12) Patent Application Publication
(10) Pub. No.: US 2025/0165889 A1
(43) Pub. Date: May 22, 2025

(54) APPARATUS AND METHOD FOR GENERATING TASK PLAN

(71) Applicant: ELECTRONICS AND TELECOMMUNICATIONS RESEARCH INSTITUTE, Daejeon (KR)

(72) Inventor: Joon Myun CHO, Daejeon (KR)

(21) Appl. No.: 18/661,938

(22) Filed: May 13, 2024

(30) Foreign Application Priority Data
Nov. 21, 2023 (KR) 10-2023-0162606

(51) Int. Cl. G06Q 10/0631; G06N 5/02

(52) U.S. Cl. CPC G06Q 10/06316; G06N 5/02

(57) ABSTRACT

The present invention relates to a method of generating a task plan, which includes constructing a causal operation network based on a knowledge base, constructing a search tree based on the knowledge base and the causal operation network, and generating a task plan based on the search tree.

### CROSS REFERENCE TO RELATED APPLICATION

The present application claims priority to Korean Patent Application No. 10-2023-0162606, filed 21 Nov. 2023, the entire contents of which are incorporated herein for all purposes by this reference.

### BACKGROUND

### 1. Technical Field

The present invention relates to an apparatus for generating a task plan and method, and more particularly, to an apparatus and method for generating a task plan that are capable of automatically generating a task plan corresponding to a sequence of operations that should be performed by autonomous things to complete a given mission.

### 2. Description of Related Art

In general, autonomous things, such as intelligent robots and autonomous vehicles, refer to devices, apparatuses, or systems that perform given tasks on their own without human intervention according to their current situations.

Among various methods of implementing autonomous things, there is a method of automatically generating a task plan (i.e., a plan composed of a series of actions to complete a task) and performing a given task based on the generated task plan.

The task plan may refer to a sequence of actions that should be performed to accomplish (i.e., succeed) a given task.

Here, the action refers to a unit operation of an autonomous thing in the environment that changes the state of the environment.

The task accomplishment (success) refers to when an autonomous thing changes the current state of the environment to a goal state (i.e., the state of the environment when the task is completed) specified by the task through the execution of a series of actions.

This method of performing a task based on a task plan symbolically expresses information related to the environment, task, and action, and uses symbolic logical operations to generate the task plan. The method of performing a task may also be referred to as symbolic automated planning technology.

Meanwhile, the related art has a problem in that only operations that have symbols as values predefined or stored in a symbolic model (knowledge base) prepared before generating the task plan may be included in the task plan.

For example, in the problem of planning a movement path of a mobile robot moving in a square-shaped space, when locations of four vertices of a square, which includes a knowledge base about the task environment, may be modeled by symbols such as ‘0_0’, ‘10_0’, ‘0_10’, and ‘10_10’ and stored in the knowledge base, only the operation of moving to the locations specified by the symbols may be included in the task plan.

As such, in the related art, new symbols (information) are not newly generated and added during the execution of a task plan algorithm, and symbols are not treated as numbers, so an arithmetic operation is not performed during the task plan. As a result, the related art may not plan operations with values newly derived or generated from individual unit information, such as the arithmetic operation. For example, the related art may not plan an operation of moving a mobile robot to an arbitrary location, such as a ⅔ point between a first vertex and a second vertex in the above example.

In the related art, in order to plan the operation of moving the mobile robot to the arbitrary location, symbols corresponding to all possible locations that may be derived from other information should be individually defined based on the arithmetic operation of numerical information such as the “⅔ point between the first vertex and the second vertex,” and stored in the knowledge base in advance. However, it is not realistically easy to generate symbols in advance of the secondary, tertiary, and even n-order information that may be derived from other information, and even if it is possible to generate the symbols, it is not possible to calculate the task plan due to the explosively increased number of symbols.

The background technology of the present invention is disclosed in Korean Patent Laid-Open Publication No. 10-2022-0116745 (Jun. 23, 2022).

### SUMMARY

The present invention provides an apparatus and method for generating a task plan that are capable of generating a task plan including operations using arbitrary numerical values as parameter values.

According to an embodiment of the present invention, a method of generating a task plan includes constructing a causal operation network based on a knowledge base, constructing a search tree based on the knowledge base and the causal operation network, and generating a task plan based on the search tree.

The knowledge base may include operation knowledge and state knowledge, the operation knowledge may include a specification regarding an operation using a variable with an arbitrary numerical value as a parameter, and the specification may include information on a name of the parameter, an expression type of the parameter, and a discretization rule for discretizing the parameter.

The expression type of the parameter may be divided into an integer type, a float type, and a double type.

The information on the discretization rule may include information on a minimum value of the parameter, a maximum value of the parameter, and a value interval.

The constructing of the search tree may include performing a process of generating a specific operation for all cases on each operation included in an operation knowledge of the knowledge base, setting at least one of all specific operations as a goal node, detecting a specific operation that has a causal relationship with a specific operation set as a top node at a current time among specific operations excluding a specific operation set as a node, and setting the detected specific operation as a parent node of a node set as the top node at the current time, and the detecting of the specific operation and the setting of the detected specific operation as the parent node of the node may be as the top node are repeatedly performed until there is no specific operation that has a causal relationship with the specific operation set as the top node at the current time.

The performing of the process of generating a specific operation for all cases on each operation included in the operation knowledge of the knowledge base may include repeatedly performing a process of selecting one operation included in the operation knowledge of the knowledge base as a goal operation and generating a specific operation of the goal operation for all cases while changing the goal operation, and repeatedly performing a process of generating a specific operation by substituting the value into the parameter while increasing a value interval recorded in a discretization rule of the goal operation from a minimum value recorded in the discretization rule of the goal operation to a maximum value recorded in the discretization rule of the goal operation to generate the specific operation of the goal operation for all the cases.

The setting of the at least one of all specific operations as the goal node may include detecting a specific operation action among all specific operations in which a part of a post-condition recorded in the knowledge base may match a part of a goal state recorded in the knowledge base and setting the detected specific action as the goal node.

The specific operation that has the causal relationship with the specific operation set as the top node at the current time may be a specific operation in which a part of a post-condition recorded in the knowledge base matches a part of a pre-condition of the specific operation set as the top node at the current time.

The generating of the task plan based on the search tree may include: detecting an operation in which a pre-condition recorded in the knowledge base matches a current state; setting the detected operation as front nodes; calculating heuristic evaluation values for each of the front nodes; detecting a front node with the smallest heuristic evaluation value; detecting a post-condition of an operation corresponding to the detected front node from the knowledge base; and updating the current state by reflecting the detected post-condition, and the detecting of the operation matching the current state, the setting of the detected operation as the front nodes, the calculating of the heuristic evaluation value, the detecting of the smallest front node, the detecting in the knowledge base, and the updating of the current state may be repeatedly performed until the current state matches a goal state.

In the calculating of the heuristic evaluation value, the heuristic evaluation values for each front node may be calculated using the causal operation network.

In the calculating of the heuristic evaluation value, when the operation set as the front node is an operation of using a numerical value as the parameter value, a numerical value substituted into a parameter may be discretized according to a discretization rule of the operation set as the front node, a specific operation corresponding to an operation using the discretized numerical value as a parameter value may be searched for in the causal operation network, a level of a hierarchy where the searched specific operation is located may be identified, and the identified level may be used as a heuristic evaluation value.

According to another embodiment of the present invention, an apparatus for generating a task plan includes: a memory in which a knowledge base is stored; and a processor connected to the memory, in which the processor constructs a causal action network based on a knowledge base, constructs a search tree based on the knowledge base and the causal action network, and generates a task plan based on the search tree.

### BRIEF DESCRIPTION OF DRAWINGS

FIGS. 1A and 1B are exemplary diagrams for describing a knowledge base.

FIG. 2 is an exemplary diagram for describing a task plan.

FIG. 3 is a block diagram illustrating an apparatus for generating a task plan.

FIG. 4 is a flowchart illustrating a method of generating a task plan.

FIG. 5 is a flowchart illustrating a method of configuring a causal action network.

FIG. 6 is a flowchart illustrating a method of constructing a search tree.

### DESCRIPTION OF EXAMPLE EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, an embodiment of an apparatus and method for generating a task plan according to the present invention will be described. In this process, thicknesses of lines, sizes of components, and the like, illustrated in the accompanying drawings may be exaggerated for clearness of explanation and convenience. In addition, terms to be described below are defined in consideration of functions in the present disclosure and may be construed in different ways by the intention of users or practice. Therefore, these terms should be defined on the basis of the contents throughout the present specification.

Prior to describing the apparatus and method for generating a task plan according to an embodiment of the present invention, terms used in the present disclosure will be described.

In the present embodiment, a state may mean a shape, a form, a location, or the like where an object involved in an operation is placed. Here, the object involved in the operation may include a target on which the operation is to be performed, a subject performing the operation, or the like. In the present embodiment, the terms “state,” “situation,” and “environment” may be used as the same meaning and may be used interchangeably. In the present embodiment, the state may be referred to as a task state.

In the present embodiment, the operation may refer to a series of physical actions performed by autonomous things. For example, autonomous things may include at least one of robots and autonomous vehicles. The operation may be a unit action that changes a state. In the present embodiment, the terms “operation,” “task,” and “action” may be used as the same meaning and may be used interchangeably. In the present embodiment, the operation may be referred to as a task operation.

In the present embodiment, mission accomplishment (success) may refer to when the autonomous things execute a series of operations to change states of various objects to a goal state specified by the mission. In the present embodiment, the terms “mission,” and “task” may be used as the same meaning and may be used interchangeably.

In the present embodiment, a knowledge base is a symbolic model that describes a domain that is a target of generation of a task plan and may refer to a database that stores knowledge, facts, or rules necessary to generate the task plan. Operation knowledge and state knowledge may be described in the knowledge base in a symbolic and logical specification language. The knowledge base may be prepared in advance by a user.

In the present embodiment, the operation knowledge may specify information related to an operation. The operation knowledge may be knowledge in which information on an operation is expressed in letters (symbols). The operation knowledge may include information on at least one unit operation.

The operation knowledge may include pre-condition knowledge and post-condition knowledge. When the operation knowledge includes information on a plurality of operations, the pre-condition knowledge and the post-condition knowledge may be described for each operation. The pre-condition knowledge may be knowledge in which conditions (i.e., pre-conditions), which should be prerequisite to execute the operation, are expressed in letters (symbols). In other words, the pre-condition knowledge may be knowledge in which conditions for determining whether the operation can be executed are expressed in letters (symbols). The post-condition knowledge may be knowledge in which how a state of an object related to the operation changes is expressed in letters (symbols) after executing the operation. In other words, the post-condition knowledge may be knowledge in which effects of executing the operation are expressed in letters (symbols). The pre-condition knowledge and post-condition knowledge may be a conjunction of unit knowledge (proposition). In the present embodiment, the pre-condition knowledge may also be referred to as precondition. In the present embodiment, the post-condition knowledge may also be referred to as pre-condition. The operation knowledge may include information on a list of parameters related to the operation. Here, the parameters related to the operation may correspond to input variables of the operation.

The operation knowledge may be expressed in a symbolic logical specification language such as “Action ( )” on a knowledge base. The post-condition knowledge may be expressed in a symbolic logical specification language such as “PRECOND: ˜” on the knowledge base, and the post-operation knowledge may be expressed in a symbolic logical specification language such as “EFFECT: ˜” on the knowledge base.

In the present embodiment, a specific operation may refer to an operation in which a specific value is substituted into a parameter.

In the present embodiment, the state knowledge may specify information related to a state. The state knowledge may be knowledge in which information on the state is expressed in letters (symbols). The state knowledge may include information on at least one object.

The state knowledge may include initial state knowledge and goal state knowledge. The initial state knowledge may be knowledge in which information on a state of each object at an initial time is expressed in letters (symbols). The goal state knowledge may be knowledge in which information on a state of each object at the time a mission is completed, that is, information on the state of the object to be achieved through the mission is expressed in letters (symbols). The initial state knowledge and the goal state knowledge may be the conjunction of the unit knowledge (proposition). In the present embodiment, the initial state knowledge may be referred to as the initial state. In the present embodiment, the goal state knowledge may be referred to as the goal state.

The initial state knowledge may be expressed in a symbolic logical specification language such as “Init ( )” on the knowledge base, and the goal state knowledge may be expressed in a symbolic logical specification language such as “Goal ( )” on the knowledge base.

In the present embodiment, a search space may refer to an information space formed by a symbolic model (knowledge base) expressed as the operation knowledge and the state knowledge. The search space may be a space for finding sequence information of a unit operation.

In the present embodiment, a search tree may represent a series of task processes using a node and an edge. The search tree may be expanded (or constructed) through the process of searching for operations executable at a current time in the search space and reflecting the effects of the searched operations in the knowledge base (state knowledge). The search tree may be divided into an operation space search tree and a state space search tree. The operation space search tree may refer to a search tree in which operations are represented by nodes and states are represented by edges. In other words, the operation space search tree may be a search tree that connects nodes corresponding to a plurality of task operations to edges corresponding to a plurality of task states. The state space search tree may refer to a search tree in which states are represented by nodes and operations are represented by edges. In other words, the state space search tree may be a search tree that connects the nodes corresponding to the plurality of task states to the edges corresponding to the plurality of task operations.

In the present embodiment, the task plan may refer to sequence information of operations in which autonomous things should be executed to achieve a mission. The task plan may refer to a path to reach the goal state from the initial state in the search space. The task plan may correspond to a path from a first node to the goal node in the search tree.

In the present embodiment, a front node may refer to a node that has no sub-node (child node). The front node is a candidate node for expansion of the search tree, and the search tree may be expanded by connecting one of the front nodes to a current node. The search tree may be expanded by repeating the process of selecting one of the front nodes.

In the present embodiment, the first node may refer to a top node of the completed search tree. In the state space search tree, the first node may refer to a state at a first time. In the operation space search tree, the first node may refer to an operation that induces the state at the first time. In the present embodiment, the first node may be referred to as a root node.

In the present embodiment, the goal node may refer to a leaf node of the completed search tree. In the state space search tree, a goal node may refer to a goal state. In the operation space search tree, the goal node may refer to an operation that induces the goal state, and there may be one or ore goal node in the operation space search tree.

In the present embodiment, the causal operation network may be information used to calculate a heuristic evaluation value for the front node in the operation space search tree. The causal operation network may be a tree structure composed of one layer each by starting from the goal node, finding causal relationships for all possible specific actions, and connecting specific actions with the causal relationships. The causal operation network may have a structure similar to the operation space search tree and may be considered to be a kind of simplified operation space search tree. The causal relationship is a directional relationship. When a part of the pre-condition knowledge of the first operation matches a part of the post-condition knowledge of the second operation, it may be defined as a causal relationship from the first operation to the second operation. Meanwhile, a method of estimating a distance (or cost) to a goal node for each front node and selecting a front node having the shortest estimated distance to the goal node among the front nodes as a node to be expanded in the next operation is called a heuristic search method, and the distance or cost to the target node is called the heuristic evaluation value.

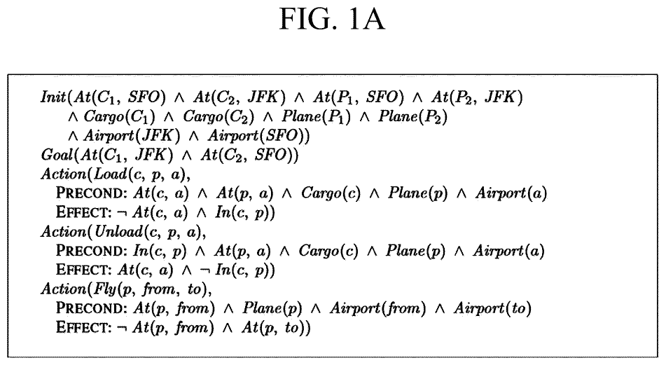

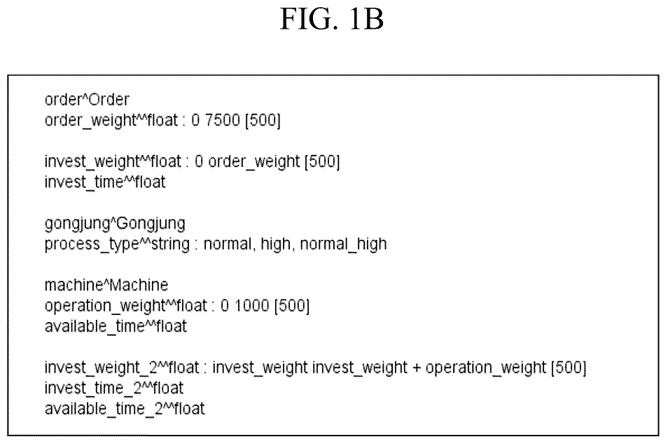

FIGS. 1A and 1B are exemplary diagrams for describing a knowledge base.

FIG. 1A illustrates a knowledge base related to a specific mission. In FIG. 1A, Init ( ) corresponds to initial state knowledge and includes definitions of symbols representing mission-related objects (cargo, plane, and airport), and information on an initial state (location) of each object.

In FIG. 1A, Goal ( ) corresponds to goal state knowledge and includes information on the goal state (location) of each object.

In FIG. 1A, Action ( ) corresponds to the operation knowledge and includes information on three unit operations (load, unload, and fly). The information on a unit operation may include information on parameters related to the unit operation, information on a pre-condition for the unit operation, and information on a post-condition (effect) for the unit operation.

Meanwhile, the operation knowledge of the knowledge base used in the apparatus for generating a task plan according to the present embodiment may include specifications regarding an operation of using variables with arbitrary numerical values as parameters. The specification of an operation of using the variables with the arbitrary numerical values as the parameters may include information on names of the parameters, expression types of the parameters, and a discretization rule for discretizing the parameters. When an operation uses a plurality of variables each having arbitrary numerical values as parameters, the names, expression types, and discretization rules may be recorded for each parameter in the specification. In the present embodiment, it goes without saying that the pre-condition knowledge and the post-condition knowledge may be included in the specification of the operation of using the variables with the arbitrary numerical values as the parameters.

Unlike the conventional knowledge base in which only predefined symbols are used as the parameter values of the operation, in the knowledge base according to the present embodiment, the arbitrary numerical values may be used as the parameter values of the operation, and therefore, in the present embodiment, the operation of using the arbitrary numerical values as the parameter values may be included in the task plan.

In the present embodiment, the expression type of the parameter may be divided into an integer type, a float type, and a double type. In the present embodiment, the information on the discretization rule may include information on a minimum value of the parameter, a maximum value of the parameter, and a value interval. The present embodiment assumes uniform discretization. In the present embodiment, the parameter may have minimum value, minimum value+ (1*value interval), minimum value+ (2*value interval), minimum value+ (n*value interval), and maximum value as values. Meanwhile, in the present embodiment, parameters other than numerical values, or a sum, difference, or product of other parameters may be expressed as the minimum and/or maximum value of the discretization rule. That is, in the discretization rule for parameters determined depending on other parameters, at least one of the minimum and maximum values may be expressed as other parameters or a sum, difference, or product of other parameters.

FIG. 1B illustrates specifications regarding parameters related to a specific operation. Specifications regarding parameters with numerical values may be recorded in the knowledge base in the form of “parameter name\hat{ }\hat{ }expression type of parameter: discretization rule.”

For example, in FIG. 1B, “order_weight\hat{ }\hat{ }float: 0 7500 [500]” may refer to when the expression type of the parameter named order_weight is float, the parameter may have a value in the range of 0 to 7500, and the value of the parameter may be discretized in units of 500.

In addition, in FIG. 1B, “invest_weight\hat{ }\hat{ }float 0 order_weight [500]” may refer to when an expression type of a parameter named invest_weight is float, the parameter may have a value in the range smaller than or equal to a value of order_weight greater than or equal to 0, and the value of the parameter may be discretized in units of 500.

Meanwhile, the specification of the operation of using the variables with the arbitrary numerical values as the parameters may not include the information on the discretization rule for discretizing the parameters. As with “invest_time” in FIG. 1B, the information on the discretization rule may be intentionally missed. The user may reduce a size of the causal operation network and increase a depth (level) of the causal operation network by intentionally missing the discretization rule for the specific parameter.

When the discretization rule for the specific parameter is missing, the number of specific operations derived from an operation including the corresponding parameter may be reduced. Since the size of the causal operation network is determined by the number of specific operations, the size of the causal operation network may be reduced when the number of specific operations is reduced. When the size of the causal operation network is reduced, the calculation of the heuristic evaluation value for the front node may be performed more quickly when constructing the search tree, so the time required to construct the search tree may be reduced.

Meanwhile, when the discretization rule for parameters, which are unrelated or less related to mission achievement, is missing, the number of specific operations derived from an operation including the corresponding parameter may be reduced. When specific operations that are unrelated or less related to mission achievement are reduced, a causal dynamic network may be constructed by considering only the specific operations that are related to the mission achievement. In this case, the depth of the causal operation network may increase. When the depth of the causal operation network increases, the heuristic evaluation value for the front node may be calculated more accurately when the search tree is constructed, and thus the search tree may be expanded more quickly. Expanding the search tree more quickly may refer to that the size of the search tree is reduced.

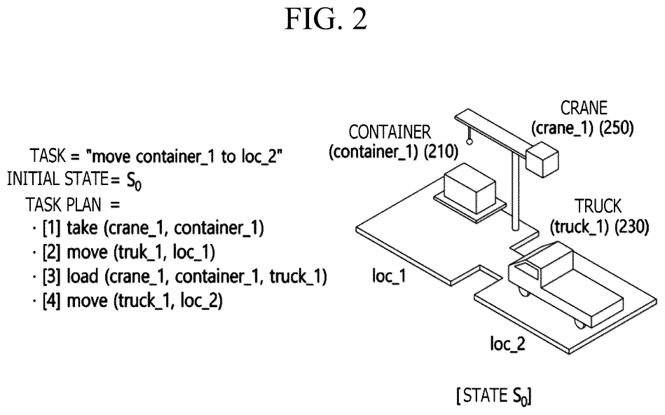

FIG. 2 is an exemplary diagram for describing a task plan.

In FIG. 2, the task may be moving a container to a second location loc_2. In FIG. 2, an initial state S₀ may be a situation in which the container is located at a first location loc_1 and a truck is located at a second location loc_2. In FIG. 2, information that the operation should be executed in the order of a first operation of lifting a container using a crane to achieve a task (mission), a second operation of moving a truck to the first location loc_1, a third operation of loading a container onto a truck using a crane, and a fourth operation of moving a truck to the second location loc_2, that is, sequence information of operations may correspond to the task plan.

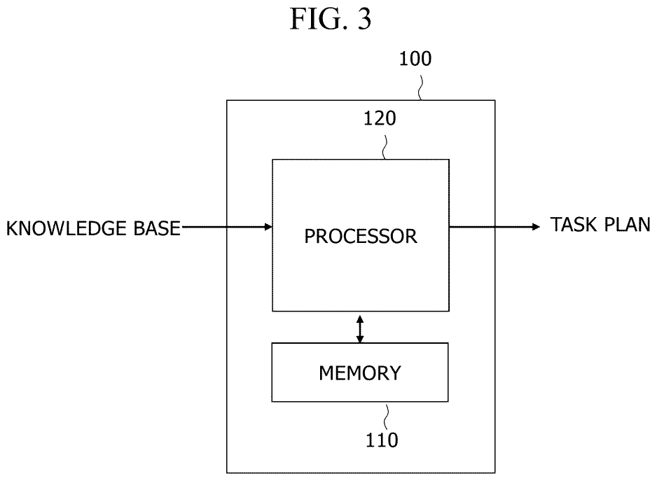

FIG. 3 is a block configuration diagram illustrating an apparatus for generating a task plan according to an embodiment of the present invention.

Referring to FIG. 3, the apparatus 100 for generating a task plan according to the embodiment of the present invention may include a memory 110 and a processor 120. The apparatus 100 for generating a task plan according to the embodiment of the present invention may further include various components in addition to the components illustrated in FIG. 3, or some of the above components may be omitted. For example, the apparatus 100 for generating a task plan according to the embodiment of the present invention may further include an input/output interface for receiving arbitrary data or outputting data calculated by the processor 120, and a user interface for interacting with a user, etc.

The memory 110 may store various types of information required during the operation of the processor 120. For example, the memory 110 may store a knowledge base related to the mission to be performed. The memory 110 may store various types of information calculated while the processor 120 operates.

At least one instruction executed by the processor 120 may be stored in the memory 110. The memory 110 may be implemented as a volatile storage medium and/or a non-volatile storage medium and may be implemented as, for example, a read only memory (ROM) and/or a random access memory (RAM).

The processor 120 may be implemented as a central processing unit (CPU) or a system on chip (SoC) and operate an operating system or applications to control a plurality of hardware or software components connected to the processor 120, thereby performing various data processing and operations. The processor 120 may be configured to execute at least one command stored in the memory 110 and store the execution result data in the memory 110.

The processor 120 may generate a task plan to achieve the target mission. Here, the target mission may refer to a target mission for which the task plan is to be generated.

Hereinafter, the method of generating a task plan according to an embodiment of the present invention will be described based on the above-described content. Some of the processes described below may be performed in an order different from the order described later or may be omitted.

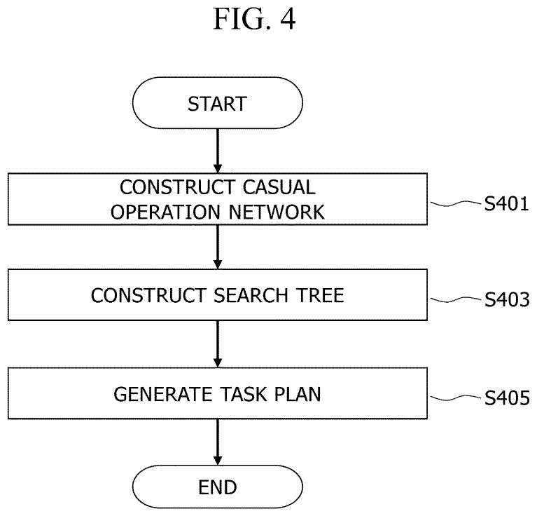

FIG. 4 is a flowchart illustrating a method of generating a task plan according to an embodiment of the present invention.

First, the processor 120 may configure a causal operation network based on a knowledge base related to the target mission (S401). Prior to operation S401, the processor 120 may receive a knowledge base related to a target mission and store the received knowledge base in the memory 110. The knowledge base related to the target mission may be prepared in advance by a user. The causal operation network may be used to calculate the heuristic evaluation value for the front node in the process of constructing a search tree.

Subsequently, the processor 120 may construct a search tree based on the knowledge base and the causal operation network related to the target mission (S403). The processor 120 may construct the search tree by sequentially expanding related nodes from the initial node to the goal node. In operation S403, the processor 120 may construct an operation space search tree.

Subsequently, the processor 120 may generate the task plan for the target mission based on the search tree (S405). The processor 120 may generate the task plan for the target mission by detecting the sequence information of the operations that autonomous things should be executed to achieve the mission from the search tree. The processor 120 may detect a path from the first node to the goal node from the search tree, and use the sequence information of the operations corresponding to the detected path as the task plan.

Meanwhile, the above-described embodiment describes that the causal operation network is constructed and the operation space search tree is configured using the causal operation network. However, in various embodiments, operation S401 is omitted and a state space search tree may be constructed in operation S403.

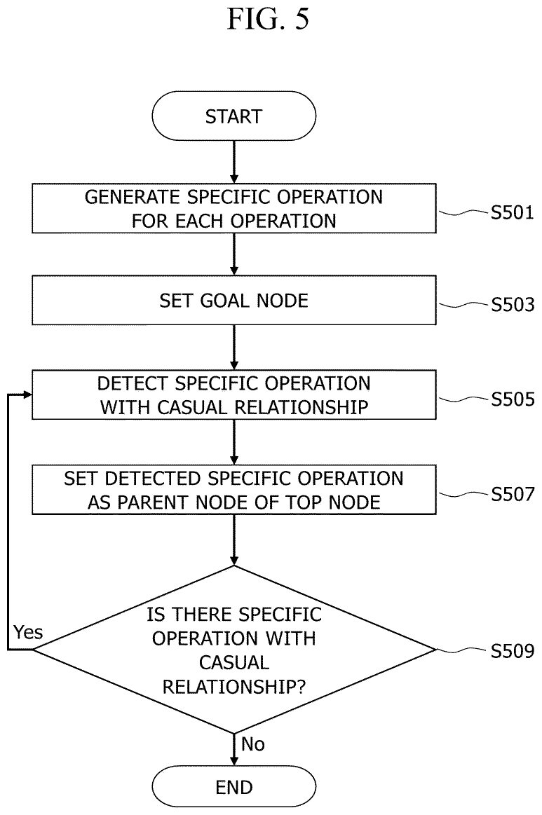

FIG. 5 is a flowchart illustrating a method of configuring a causal action network.

First, the processor 120 may perform a process of generating a specific operation for all cases on each operation included in the operation knowledge of the knowledge base (S501). In operation S501, the processor 120 may select one of the operations included in the operation knowledge of the knowledge base as the goal operation, and repeatedly perform the process of generating the specific operation of the goal operations for all the cases while changing the goal operation. In operation S501, the processor 120 may repeatedly perform the process of generating the specific operation by substituting the value into the parameter while increasing the value interval recorded in the discretization rule of the goal operation from a minimum value recorded in the discretization rule of the goal operation to the maximum value recorded in the discretization rule of the goal operation to generate the specific operation of the goal operation for all the cases. In operation S501, the processor 120 may generate the specific operation considering only when the discretized value is substituted into the parameter.

For example, assuming that a parameter related to operation A is one parameter a, the a parameter is a parameter that has a numerical value as a value, and the discretization rule for the a parameter is (0, 1000, and [500]), operation A (0) indicating operation A when the value of the a parameter is 0, operation A (500) indicating operation A when the value of the a parameter is 500, and operation A (1000) indicating operation A when the value of the a parameter is 1000 each may correspond to a specific operation for operation A.

In operation S501, the processor 120 may receive information on a missing target parameter from an external source (e.g., a user), and prior to generating the specific operation, the discretization rule corresponding to the missing target parameter may be temporarily missing from the knowledge base. Accordingly, the specific operation derived from the operation using the missing target parameter as the parameter may be reduced. In order to receive the information about the missing target parameter from the outside, the present embodiment may further include the user interface.

Subsequently, the processor 120 may set at least one of all specific operations (specific operations for all the operations included in the operation knowledge of the knowledge base) as the goal node (S503). In operation S503, the processor 120 may detect a specific operation in which part of the post-condition matches part of the goal state recorded in the knowledge base among all the specific operations, and set the detected specific operation as the goal node. The goal node may constitute a one-level level of the causal operation network.

Next, the processor 120 may detect the specific operation that has the causal relationship with the specific operation set as the top node at the current time among the specific operations excluding the specific operation set as the node (S505), and select the detected specific operation as a parent node (higher node) of the top node at the current time (S507). As the parent node of the top node is added, the parent node may become a new top node.

In operation S507, the processor 120 may detect the specific operation in which a part of the post-condition matches a part of the pre-condition of the specific operation set as the top node at the current time, and the specific operation detected in this way may be the specific operation that has the causal relationship with the specific operation set as the top node at the current time. The processor 120 may confirm the pre-condition and post-condition of each specific operation from the knowledge base.

For example, the processor 120 may detect the specific operation that has the causal relationship with the specific operation set as the goal node among all the specific operations excluding the specific operation set as the goal node, and select the detected specific operation as the parent node of the goal node. The parent node of the goal node may constitute a two-level level of the causal operation network.

Next, the processor 120 may determine whether there is the specific operation that has the causal relationship with the specific operation set as the top node at the current time among the specific operations excluding the specific operation set as the node (S509). That is, the processor 120 can determine whether, there is the specific operation that has the causal relationship with the specific operation set as the top node at the current time among the specific operations that are not set as nodes (have not ever been set as nodes).

When there is no specific operation that has the causal relationship with the specific operation set as the top node at the current time among the specific operations excluding the specific operation set as the node, the processor 120 may terminate the process constituting the causal operation network.

On the other hand, when there is the specific operation that has the causal relationship with the specific operation set as the top node at the current time among the specific operations excluding the specific operation set as the node, the processor 120 may return to operation S505.

The level of the layer where the specific operation is located in the causal operation network may be used as the heuristic evaluation value of the front node corresponding to the corresponding specific operation in the operation space search tree.

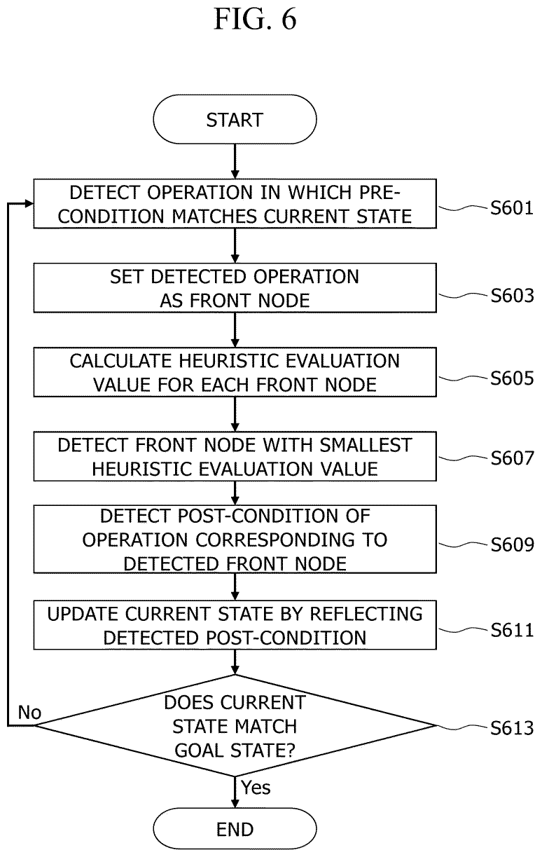

FIG. 6 is a flowchart illustrating a method of constructing an operation space search tree.

First, the processor 120 may detect an operation in which the pre-condition recorded in the knowledge base matches the current state (S601) and set the detected operation as the front node (S603). In operation S601, the processor 120 may detect an operation that can be executed at the current time. The current state may refer to the state of each object at the current time and may be continuously updated starting from the initial state. In operation S603, one or more operations may be set as the front node.

Next, the processor 120 may calculate the heuristic evaluation values for each front node (S605). In operation S605, the processor 120 may calculate the heuristic evaluation values for each front node using the causal operation network. In operation S605, when the operation set as the front node is an operation of using the numerical values as the parameter values, the processor may discretize the numerical values substituted into the parameters according to the discretization rule of the corresponding operation recorded in the knowledge base, search for the specific operation corresponding to the operation of using the discretized numerical values as the parameter values in the causal operation network, identify the level of the layer where the searched specific operation is located, and use the identified level as the heuristic estimation value.

For example, assuming that the parameter operation_weight of operation A set as the front node has a value of 523 and the discretization rule of the parameter is (0, 1000, and [500]), the processor 120 may obtain a value of 500 by discretizing the parameter according to the discretization rule. Thereafter, the processor 120 may search for the specific operation corresponding to operation A with the operation_weight value of 500 among the specific operations (nodes) constituting the causal operation network, and identify the level of the level where the searched specific operation is located, and use the identified level as the heuristic evaluation value.

Next, the processor 120 may detect the front node with the smallest heuristic evaluation value among the front nodes (S607), detect the post-condition of the operation corresponding to the detected front node in the knowledge base (S609), and update the current state to reflect the detected post-condition (S611). In operation S611, the processor 120 may update the current state using the post-condition of the operation corresponding to the front node with the smallest heuristic evaluation value.

Next, the processor 120 may determine whether the current state matches the goal state recorded in the knowledge base (S613).

When the current state matches the goal state, the processor 120 may terminate the process of searching for the search tree. On the other hand, when the current state does not match the goal state, the processor 120 may return to operation S601. The processor 120 may expand the search tree by repeating operations S601 to S613.

As described above, the apparatus and method for generating a task plan according to an embodiment of the present invention can use the variables with the arbitrary numerical values as the parameters of the operation, and thus include the operation of using the arbitrary numerical values as the parameter values in the task plan. In addition, the apparatus and method for generating a task plan according to the embodiment of the present invention can effectively reduce the size of the search tree that increases explosively as the variables with the arbitrary numerical values are used as the parameters of the operation.

According to one aspect of the present invention, by using variables with arbitrary numerical values as operation parameters, it is possible to include the operation using the arbitrary numerical values as parameter values in the task plan.

In addition, according to one aspect of the present invention, by using variables with arbitrary numerical values as the operation parameters, it is possible to effectively reduce the size of the explosively increasing search tree.

What is claimed is:

1. A method of generating a task plan, which is performed by a computing device including a processor, comprising:
constructing a causal operation network based on a knowledge base;
constructing a search tree based on the knowledge base and the causal operation network; and
generating a task plan based on the search tree.

2. The method of claim 1, wherein the knowledge base includes operation knowledge and state knowledge,
the operation knowledge includes a specification regarding an operation using a variable with an arbitrary numerical value as a parameter, and
the specification includes information on a name of the parameter, an expression type of the parameter, and a discretization rule for discretizing the parameter.

3. The method of claim 2, wherein the expression type of the parameter is divided into an integer type, a float type, and a double type.

4. The method of claim 2, wherein the information on the discretization rule includes information on a minimum value of the parameter, a maximum value of the parameter, and a value interval.

5. The method of claim 1, wherein the constructing of the search tree includes:
performing a process of generating a specific operation for all cases on each operation included in an operation knowledge of the knowledge base;
setting at least one of all specific operations as a goal node;
detecting a specific operation that has a causal relationship with a specific operation set as a top node at a current time among specific operations excluding a specific operation set as a node; and
setting the detected specific operation as a parent node of a node set as the top node at the current time, and
the detecting of the specific operation and the setting of the detected specific operation as the parent node of the node set as the top node are repeatedly performed until there is no specific operation that has a causal relationship with the specific operation set as the top node at the current time.

6. The method of claim 5, wherein the performing of the process of generating a specific operation for all cases on each operation included in the operation knowledge of the knowledge base includes:
repeatedly performing a process of selecting one operation included in the operation knowledge of the knowledge base as a goal operation and generating a specific operation of the goal operation for all cases while changing the goal operation; and
repeatedly performing a process of generating a specific operation by substituting the value into the parameter while increasing a value interval recorded in a discretization rule of the goal operation from a minimum value recorded in the discretization rule of the goal operation to a maximum value recorded in the discretization rule of the goal operation to generate the specific operation of the goal operation for all the cases.

7. The method of claim 5, wherein the setting of the at least one of all specific operations as the goal node includes detecting a specific operation action among all specific operations in which a part of a post-condition recorded in the knowledge base matches a part of a goal state recorded in the knowledge base and setting the detected specific action as the goal node.

8. The method of claim 5, wherein the specific operation that has the causal relationship with the specific operation set as the top node at the current time is a specific operation in which a part of a post-condition recorded in the knowledge base matches a part of a pre-condition of the specific operation set as the top node at the current time.

9. The method of claim 1, wherein the generating of the task plan based on the search tree includes:
detecting an operation in which a pre-condition recorded in the knowledge base matches a current state;
setting the detected operation as front nodes;
calculating heuristic evaluation values for each of the front nodes;
detecting a front node with the smallest heuristic evaluation value;
detecting a post-condition of an operation corresponding to the detected front node from the knowledge base; and
updating the current state by reflecting the detected post-condition, and
the detecting of the operation matching the current state, the setting of the detected operation as the front nodes, the calculating of the heuristic evaluation value, the detecting of the smallest front node, the detecting in the knowledge base, and the updating of the current state are repeatedly performed until the current state matches a goal state.

10. The method of claim 9, wherein, in the calculating of the heuristic evaluation value, the heuristic evaluation values for each front node is calculated using the causal operation network.

11. The method of claim 10, wherein, in the calculating of the heuristic evaluation value, when the operation set as the front node is an operation of using a numerical value as the parameter value, a numerical value substituted into a parameter is discretized according to a discretization rule of the operation set as the front node, a specific operation corresponding to an operation using the discretized numerical value as a parameter value is searched for in the causal operation network, a level of a hierarchy where the searched specific operation is located is identified, and the identified level is used as a heuristic evaluation value.

12. An apparatus for generating a task plan, comprising:
a memory in which a knowledge base is stored; and
a processor connected to the memory,
wherein the processor constructs a causal action network based on the knowledge base, constructs a search tree based on the knowledge base and the causal action network, and generates a task plan based on the search tree.

13. The apparatus of claim 12, wherein the knowledge base includes operation knowledge and state knowledge,
the operation knowledge includes a specification regarding an operation using a variable with an arbitrary numerical value as a parameter, and
the specification includes information on a name of the parameter, an expression type of the parameter, and a discretization rule for discretizing the parameter.

14. The apparatus of claim 13, wherein the information on the discretization rule includes information on a minimum value of the parameter, a maximum value of the parameter, and a value interval.

15. The apparatus of claim 12, wherein, when the processor constructs the search tree based on the knowledge base and the causal action network,
the processor performs performing a process of generating specific operations for all cases on each operation included in the operation knowledge of the knowledge base, setting at least one of all the specific operations as a goal node, detecting a specific operation having a causal relationship with a specific operation set as a top node at a current time among the specific operations excluding a specific operations set as a node, and setting the detected specific operation as a parent node of the node set as the top node at the current time, and
repeatedly performs detecting the specific operation having the causal relationship with the specific operation and setting the detected specific operation as the parent node of the node set as the top node until there is no specific operation having the causal relationship with the specific operation set as the top node at the current time.

16. The apparatus of claim 15, wherein, when performing the process of generating specific operations for all cases on each operation included in the operation knowledge of the knowledge base,
the processor selects one operation included in the operation knowledge of the knowledge base as a goal operation, and repeatedly performs the process of generating the specific operation of the goal operations for all the cases while changing the goal operation, and
repeatedly performs a process of generating a specific operation by substituting the value into the parameter while increasing a value interval recorded in a discretization rule of the goal operation from a minimum value recorded in the discretization rule of the goal operation to a maximum value recorded in the discretization rule of the goal operation to generate the specific operation of the goal operation for all the cases.

17. The apparatus of claim 15, wherein, when setting the at least one of all the specific operations as the goal node, the processor includes detecting a specific operation action among all specific operations in which part of a post-condition recorded in the knowledge base matches part of a goal state recorded in the knowledge base and setting the detected specific action as the goal node.

18. The apparatus of claim 15, wherein the specific operation having the causal relationship with the specific operation set as the top node at the current time is the specific operation in which a part of a post-condition recorded in the knowledge base matches a part of a pre-condition of the specific operation set as the top node at the current time.

19. The apparatus of claim 12, wherein, when the task plan is generated based on the search tree,
the processor performs detecting an operation in which a pre-condition recorded in the knowledge base matches a current state, setting the detected operation as a front node, calculating heuristic evaluation values for each front node, detecting the front node having a smallest heuristic evaluation value, detecting a post-condition of the operation corresponding to the detected front node in the knowledge base, and updating the current state by reflecting the detected post-condition, and
repeatedly performs the detecting of the operation matching the current state, the setting of the detected operation as the front node, the calculating of the heuristic evaluation value, the detecting of the smallest front node, the detecting in the knowledge base, and the updating of the current state until the current state matches a goal state.

20. The apparatus of claim 19, wherein, when performing the calculating of the heuristic evaluation value, the processor calculates the heuristic evaluation values for each of the front nodes using the causal operation network.
